(19) United States
(12) Patent Application Publication
(10) Pub. No.: US 2008/0253225 A1
(43) Pub. Date: Oct. 16, 2008

(54) Seismic Cable Positioning Using Coupled Inertial System Units

(76) Inventors: Kenneth E. Welker, Nesoya (NO); Vidar A. Husom, Asker (NO)

Correspondence Address: WesternGeco,L. L. C.;Intellecutal Property Department, P.O. Box 2469, Houston, TX, 77252-2469, US

(21) Appl. No.: 10/597,227

(22) PCT Filed: Jan. 29, 2004
(86) PCT No.: PCT/US04/02477

§ 371 Date: Jul. 17, 2006

(51) Int. Cl. G01V 1/38

(52) U.S. Cl. 367/17; 367/19; 367/20

(57) ABSTRACT

An apparatus and a method of its use in a marine seismic survey are disclosed. The apparatus includes a seismic survey object (106) and an inertial measurement device (130) coupled to the seismic survey object (106). The method includes taking inertial measurements of the movement of selected points on a seismic spread relative to at least one known point, and applying the inertial measurements to the known point to determine the positions of the selected points.

### BACKGROUND OF THE INVENTION

1. Field of the Invention

The invention pertains to seismic surveying and, more particularly, to a method and apparatus for more accurately determining the position of seismic survey objects in a marine seismic survey.

2. Description of the Related Art

Seismic exploration is conducted on both land and in water. In both environments, exploration involves surveying subterranean geological formations for hydrocarbon deposits. A survey typically involves deploying acoustic source(s) and acoustic sensors at predetermined locations. The source(s) imparts acoustic waves into the geological formations. Features of the geological formation reflect the acoustic waves to the sensors. The sensors receive the reflected waves, which are the processed to generate seismic data. Analysis of the seismic data may then indicate probable locations of the hydrocarbon deposits.

Accurate knowledge of the positions of the seismic survey objects, e.g., acoustic sources and acoustic receivers, is important to the accuracy of the analysis. In land surveys, the problem of positioning is different from in a marine situation because environmental conditions are different. Sources, sensors, and other objects, once placed, usually do not shift to any great degree. Marine surveys, however, are more dynamic, and sources, sensors and other objects move at a much higher frequency due to environmental conditions more difficult to control.

Marine surveys come in at least two types. In a first, a spread of streamers and sources is towed behind a survey vessel. Each streamer includes multiples sensors and devices, including acoustic receivers. In a second type, a spread of seismic cables, each of which includes multiple sensors, is laid on the ocean floor, or sea bottom, and a source is towed from a survey vessel. In both cases, many factors complicate determining the position of the sensors, including wind, currents, water depth, and inaccessibility.

In the second type of marine survey, where the spread of seismic cables is laid on the sea floor, much attention is paid to the positioning of the seismic cables as they are laid. One important consideration is the shape of the seismic cables as they are deployed. The shape of the seismic cable in the water during deployment, typically a catenary shape, should be known or projected if it is to be controlled effectively during deployment. Control is needed to optimize the deployment speed and accuracy. Control is also desired to avoid tangling the seismic cable with other obstructions, such as other cables or sub-sea devices. Remedial action can be taken to avoid such problems and improve the safety of sub-sea operations.

Current techniques apply various modeling techniques to project the shape and/or position of the seismic cable during deployment. These models consider the physical characteristics of the seismic cable (e.g., weight, diameter, etc.) and account for the effect of predicted sea currents on the seismic cable as it descends to the sea floor. However, such methods provide only a model, or projection, of the seismic cable's shape and are predicated on a limited knowledge of the sea's properties.

Thus, deployment, retrieval and seismic surveying using towed streamers or ocean bottom cable requires position coordinate estimates of the seismic spread, source and receivers be known with varying degrees of certainty depending on the operational and survey requirements. In order to achieve this various methods of coordinate estimation are used. There are two primary methods to estimate coordinates, either by direct measurement or by a force-resultant model computation based on force measurements. Methods using direct measurements include GPS, acoustics distances, compass directions and others are also sometimes used.

The present invention is directed to resolving, or at least reducing, one or all of the problems mentioned above.

### SUMMARY OF THE INVENTION

The present invention comprises an apparatus and a method of its use in a marine seismic survey. The apparatus comprises a seismic survey object and an inertial measurement device coupled to the seismic survey object. The method comprises taking inertial measurements of the movement of selected points on a seismic spread relative to at least one known point, and applying the inertial measurements to the known point to determine the positions of the selected points.

### BRIEF DESCRIPTION OF THE DRAWINGS

The invention may be understood by reference to the following description taken in conjunction with the accompanying drawings, in which like reference numerals identify like elements, and in which:

FIG. 1 is a three-dimensional, perspective view of a seismic survey;

FIG. 2 illustrates a second seismic survey in an embodiment alternative to that in FIG. 1 in a three-dimensional, perspective view;

FIG. 3 depicts one inertial positioning device of the embodiment in FIG. 1;

FIG. 4 illustrates the deployment of one seismic cable in the survey of FIG. 1 in accordance with the present invention and the application of an optional acoustic ranging calibration technique;

FIG. 5 depicts a computing apparatus as may be used in implementing some aspects of the present invention;

FIG. 6 illustrates the second seismic survey of FIG. 2 during the conduct of the survey itself;

FIG. 7 illustrates an optional acoustic calibration technique as applied to the seismic survey of FIG. 2;

FIG. 8 illustrates a third seismic survey in an embodiment alternative to those in FIG. 1 and FIG. 2 in a three-dimensional, perspective view; and

FIG. 9 illustrates an open-loop Kalman filtering technique as may be used to calibrate the inertial units.

While the invention is susceptible to various modifications and alternative forms, the drawings illustrate specific embodiments herein described in detail by way of example. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF THE INVENTION

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort, even if complex and time-consuming, would be a routine undertaking for those of ordinary skill in the art having the benefit of this disclosure.

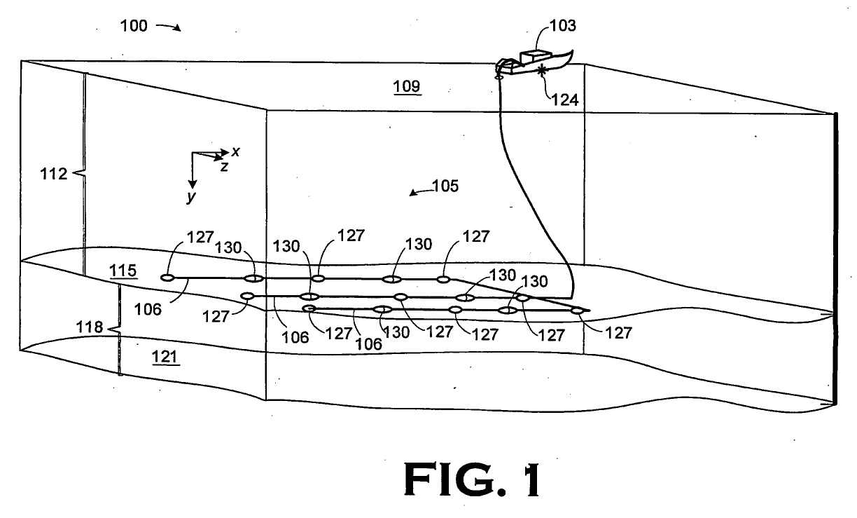

FIG. 1 is a three-dimensional, perspective view of a first seismic survey 100, in which a survey vessel 103 has deployed a seismic spread 105. The seismic spread 105 includes a plurality of seismic cables 106 in accordance with the present invention. The seismic cables 106 have been deployed from the survey vessel 103 at the surface 109 of a body of water 112, through the water 112, to the bottom 115. The seismic cables 106 are deployed in preparation for surveying a subterranean geologic formation 118 beneath the bottom 115 and presenting at least one reflector 121. As will be appreciated by those skilled in the art having the benefit of this disclosure, the size of the seismic survey 100 will be implementation specific. Thus, the number of seismic cables 106 employed in the seismic survey 100 is not material to the practice of the invention.

The survey vessel 103 or second vessel dedicated as a source vessel, also has mounted thereon an acoustic source 124 in accordance with conventional practice. In the illustrated embodiment, the acoustic source 124 is an air gun or a vibrator, but any suitable acoustic source known to the art may be used. The seismic cables 106 each include a plurality of sensor modules 127, each housing a variety of instruments including an acoustic receiver (not shown), e.g., a hydrophone or a geophone. Since the seismic cable 106 is deployed on the bottom 115, the acoustic receivers in the illustrated embodiment are geophones. The seismic cables 106 also include, in accordance with the present invention, a plurality of inertial positioning devices (“IPDs”) 130, described more fully below, including at least one inertial measurement unit (“IMU”, not shown in FIG. 1), also as discussed more fully below.

In the illustrated embodiment, the body of water 112 is an ocean, and the bottom 115 may therefore be referred to as a “seabed” or an “ocean bottom.” Accordingly, the seismic cable 106 may be referred to as an “ocean bottom cable” (“OBC”). However, the invention is not so limited. The body of water 112 may be any body of water, whether saltwater, freshwater, or brackish water. The invention may therefore be employed in marine environments, lakes, and other bodies of freshwater, or in transitional zones including brackish water. Similarly, the invention may be deployed on seismic streamers, as will be discussed further below. Note that the term “marine” is used in accordance with industry usage, and describes a survey conducted in any aquatic environment regardless of whether the water is salt, fresh, or brackish.

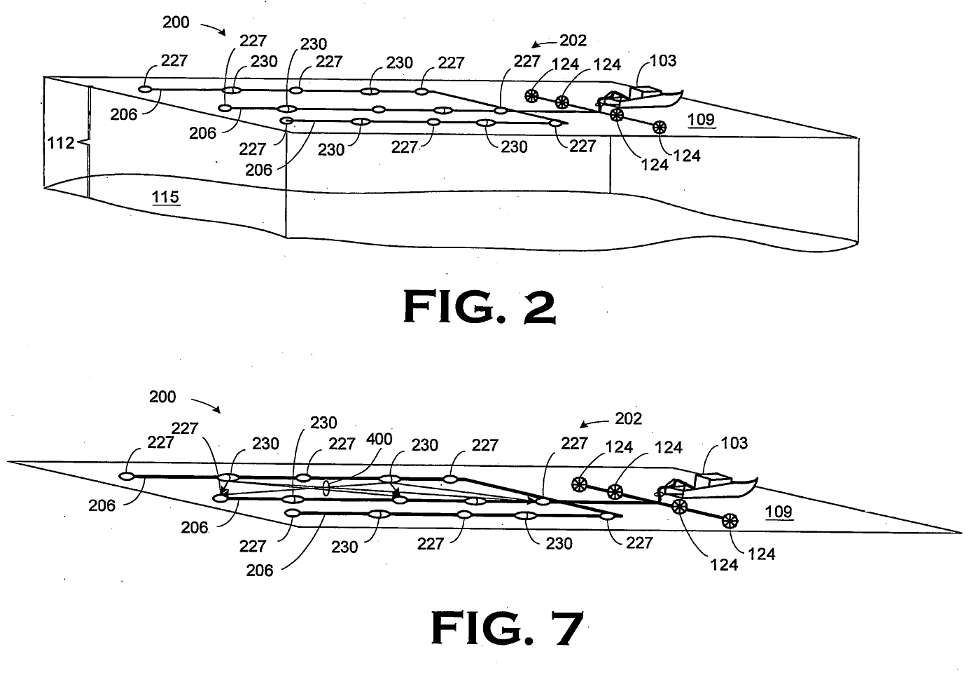

The invention is also not limited to marine surveys employing OBCs 106. Consider, for instance, the seismic survey 200, illustrated in FIG. 2. Like the seismic survey 100, the seismic survey 200 may be conducted in salt, fresh, or brackish waters. However, the seismic survey 200 employs a seismic spread 202 of seismic cables 206 deployed near the surface 109 of the water 112 and towed from the survey vessel 103. In this type of marine survey, the seismic cables 206 are referred to as “streamers.” As those in the art having the benefit of this disclosure will appreciated, the streamers 206 may be deployed at varying depths below the surface 112, although still near the surface 109. The seismic cables 206 include sensor modules 227 housing appropriate acoustic sensors (not shown), i.e., hydrophones, and IPDs 230. The seismic cables 206 may also include equipment having no direct analog in the seismic streamers 106, such as steering devices (not shown), commonly known as “birds” or “Q-fins”. In conventional practice, birds include a battery, a power system, a communications interface, and a compass that are all employed in their function of steering the respective seismic cables 206. However, conventional birds have been modified in accordance with the present invention, as described more fully below, to implement the present invention. Thus, the IPDs 230 in the seismic survey 200 may also be used to steer the streamers 206 and, hence, the seismic spread 202.

Returning to FIG. 1, as mentioned above, the seismic cables 106 include, in accordance with the present invention, a plurality of IPDs 130. The IPDs 130 can be fully integrated with the seismic cable electronics system; operated as an autonomous system independent of the seismic cable electronics system with its own power supply and communication; or as a combination of both integrated and autonomous operation. In the illustrated embodiment, the IPDs 130 are separated from and independent of the sensor modules 127. It may therefore be convenient to provide the IPDs 130 power, control, and data electronics independent of those for the seismic cables 106, or in some combination of integration and autonomy.

The IPDs 130 do not steer the seismic cable 106 during deployment in the embodiment of FIG. 1, but are instead used to determine its position. Some embodiments may therefore remove the IMUs of the IPDs 130 to the sensor modules 127. In such embodiments, it may be more convenient to provide the IMUs with power, control, and data electronics more fully integrated with those of the seismic cable 106.

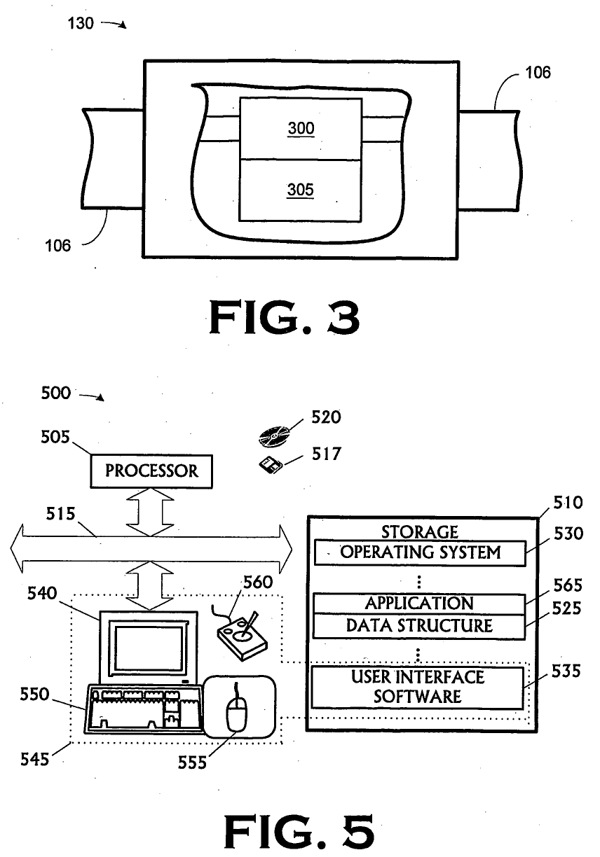

Turning now to FIG. 3, the IPDs 130 may be implemented by combining an IMU 300 with selected components 305, e.g., the battery, power system, and communication interfaces, of conventional “birds” used to steer streamers. The IMU 300 may be, for instance, micro-electromechanical system (“MEMS”) inertial measurement unit, comprising 3-axis accelerometers and gyroscopes (not shown) and a control system (also not shown) implemented in software. One suitable MEMS based inertial measurement unit is micro-INS commercially offered by Imego AB, which may be contacted at:
Arvid Hedvalls backe 4
   411 33 Göteborg
      Sweden
Ph: +46-31-750 18 00
Fax: +46-31-750 18 01
   This micro-INS can navigate in conditions as difficult as 50 g accelerations and rotation speeds up to 3000 deg/s, combined with a bandwidth of at least 0-200 Hz. All degrees of freedom are computed and available to the user, such as yaw, pitch and roll angles, and position. Currently, the micro-INS is constructed in a 50 mm cube, and efforts are being made to reduce this size further. However, other small IMUs may be used in alternative embodiments. In one embodiment, the inertial measurement devices may be sampled at 1000 Hz using 24-bit analog-to-digital (“A/D”) converters. The control system converts sensor data into a coordinate system that can be used by other systems.

The IPDs 130 of the illustrated embodiment are operated as an autonomous system, independent of the seismic cable electronics system, with its own power supply and communication system. When the main seismic cable power is up, the IPDs 130 are powered from the survey vessel 103, and communicate by primary communications. When the main power is down, the IPDs 130 are powered from the “bird” battery and communicate using secondary communications. As noted earlier, alternative embodiments may implement these functionalities differently.

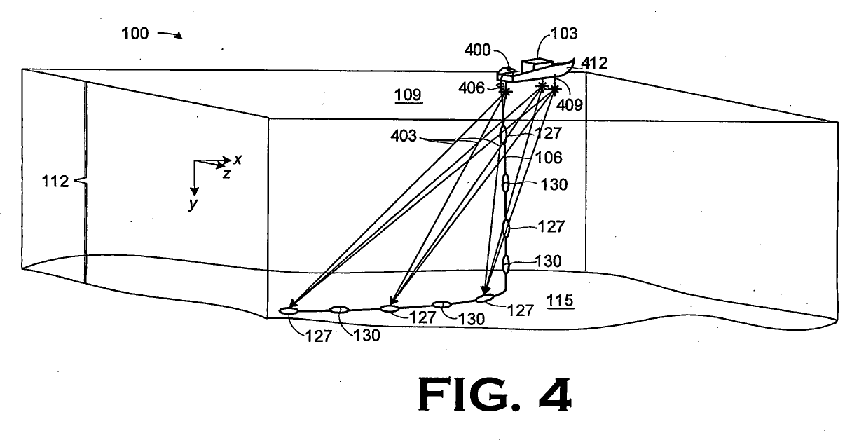

FIG. 4 illustrates the deployment of a single seismic cable 106 of the spread 105 in FIG. 1. As the seismic cable 106 is deployed, environmental conditions, such as wind and current, impart forces on the seismic cable 106 and the vessel 103. These forces distort the path of the seismic cable 106 along one or more of the three coordinate axes x, y, and z, causing deviations in the path of descent. These deviations, in turn, affect the position of the sensor modules 130 on the bottom 160.

In accordance with the present invention, the seismic cable 106 is deployed into the water 112 at a known point, e.g., the point 400. The known point 400 is a fixed reference point on the back deck of the deployment vessel 103 where the IPD/IMU coordinates are initiated. Note that the point 400 is “known” in the sense that its position can be estimated with relatively high accuracy, e.g., much better accuracy than is needed for the estimation of the position of the sensor modules. The position of the point 400 can be known, for example, from Global Positioning System (“GPS”) measurements from a GPS receiver with antenna (not shown) aboard the survey vessel 103. A GPS receiver may be placed on the equipment used to deploy the seismic cable 106 into the water 112, for instance, just before the IPD 130 leaves the deployment device. As the seismic cable 106 descends to the bottom 115, the aforementioned environmental conditions cause the seismic cable 106 to deviate in all three directions. The IMUs 300, shown in FIG. 3, of the IPDs 130 measure these deviations and the descent and transmit them over the seismic cable 106 to the survey vessel 103.

The survey vessel 103 houses a data collection system (not shown) that may also, in some embodiments, be used to determine the positions of the IPDs 130, 230. FIG. 5 illustrates an exemplary computing apparatus on which such processing may be performed. The computing apparatus 500 includes one or more processors 505 communicating with storage 510 over a bus system 515. The storage 510 may include a hard disk and/or random access memory (“RAM”) and/or removable storage such as a zip magnetic disk 517, removable hard drive (not shown), or an optical disk 520. The storage 510 is encoded with one or more data structures 525 storing, inter alia, the known deployment point 400, the measured deviations, and the measured descent acquired as discussed above, an operating system 530, user interface software 535, and an application 565. The user interface software 535, in conjunction with a display 540, implements a user interface 545. The user interface 545 may include peripheral I/O devices such as a keypad or keyboard 550, a mouse 555, or a joystick 560. In the illustrated embodiment, the user interface 545 is a graphical user interface (“GUI”), but any suitable interface known to the art may be employed.

The processor 505 runs under the control of the operating system 530, which may be practically any operating system known to the art. The application 565 is invoked by the operating system 530 upon power up, reset, or both, depending on the implementation of the operating system 530. The computing apparatus 500 may be, for instance, a rack-mounted personal computer. Similarly, the computing apparatus 500 may be implemented as a workstation. However, this is not necessary to the practice of the invention, and any suitable computing apparatus may be employed.

Note that the physical location at which the processing occurs is not material to the practice of the invention. The data may be processed at the point of collection, e.g., aboard the survey vessel 103 in FIG. 1. The positioning data is typically processed aboard the seismic vessel 103 in FIG. 1, and may be reprocessed later at some processing facility remote from where it is collected. The positioning data may be delivered to a point of reprocessing in any convenient manner. For instance, the positioning data can be wirelessly transmitted to the reprocessing facility or may be encoded on a storage medium that is then physically transported to the processing facility.

A computing apparatus, such as the one illustrated in FIG. 5, then applies the measured deviations and the measured descent to the known deployment point 400 to determine the position of the seismic cable 106 on the bottom 115. More precisely, the positions of the IPDs 130 can be determined in this manner, and the positions of the sensor modules 127 can be inferred or calculated based on the positions of the IPDs 130 and other information. For instance, depending on the implementation, the positions of the sensor modules 127 can be determined from the positions of the IPDs 130 and their distance and direction from the sensor modules 127. Note that it is usually the positions of the sensor modules 127 that it is particularly desirable to know. Thus, embodiments in which the IMUs are included in the sensor modules 127 may be preferred since the positions of the IMUs will very nearly define the positions of the sensor modules 127. However, this is not necessary to the practice of the invention.

For instance, in the embodiment of FIG. 1, the IPDs 130 and the sensor modules 127 may be located at known points on the seismic cable 106. The positions of the IPDs 130 on the bottom 115 can then be determined as described above. The shape and position of the seismic cable 106 can then be derived from the positions of the IPDs 130. Finally, the positions of the sensor modules 127 can then be determined from the shape of the seismic cable 106 and the known points along the seismic cable 106 at which the sensor modules 127 are located.

Returning now to FIG. 2, the IPDs 230 can be implemented by replacing the compasses in conventional birds with inertial measurement units, such as the aforementioned inertial measurement units comprising MEMS 3-axis accelerometers and gyroscopes. The IPDs 230 will therefore also include the battery, power system, and communication interfaces of conventional “birds”. The IPDs 230, like the IPDs 130 in FIG. 1, are operated as an autonomous system independent of the seismic cable electronics system with its own power supply and communication. When the main streamer power is up the IPDs 230 are powered from the survey vessel 103, and communicate by primary communications. When main power is down the IPDs 230 are powered from the “bird” battery and communicate using secondary communications.

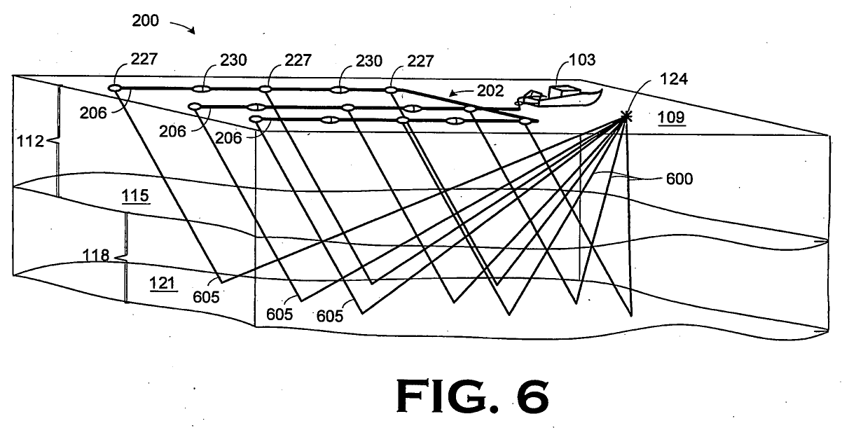

In some embodiments, such as the seismic survey 200 in FIG. 2, the invention may be used after deployment and during the survey itself. FIG. 6 illustrates the seismic survey 200 of FIG. 2 during the actual conduct of the survey. For the sake of clarity, FIG. 6 shows only a single acoustic source 124 and has removed it from the seismic spread 202. The acoustic source 124 generates a plurality of seismic waves 600 (not all indicated) that propagate through the water 112, penetrate the seabed 115, and are reflected by the reflector 121. The reflected waves 605 are then received by the sensor modules 227. The sensor modules 227 digitize the reflected waves 605 and transmits them to the data collection system (not shown) aboard the survey vessel 103. The seismic survey 200 described above can be conducted in accordance with conventional practice.

However, as will be appreciated by those skilled in the art, environmental conditions, such as currents and winds, will frequently re-position the streamers 206 of the seismic spread 202. In conventional practice, a seismic spread 200 will include one or more birds and/or steering devices to steer the streamers and maintain their desired position. The IPDs 230 are, also as mentioned above, modified birds or steering devices that can still be used for steering the streamers 206. During deployment of the survey equipment, subsequently during the conduct of the survey, and post survey during the retrieval of the equipment, the inertial measurement units 300 of the IPDs 230 may take inertial measurements of their deviation and transmit them to the data collection unit aboard the survey vessel 103. The data collection system can analyze the inertial measurements and then issue appropriate steering commands to the IPDs 230 to maintain the respective streamer 206 in its desired position, which can vary depending on the immediate objective, e.g., to improve the survey or address a safety concern. Note that this is but one example in which the present invention may be employed post-deployment and during the conduct of the seismic survey 200. Other uses will become apparent to those skilled in the art having the benefit of this disclosure.

It may sometimes be desirable to obtain an additional degree of accuracy in the positions of sensor modules 127. After the IPD/IMU leaves the back deck of the deployment vessel 103, the coordinate estimates are in reference to the initial coordinates and the measurements of change relative to this point start to degrade with time until they are refreshed with a coordinate estimate update from the navigation system. The measurements of the IPDs 130, 230 can be supplemented by other measurements, for instance, by tightly integrating one-dimensional measures such as acoustic ranges, range differences and pressure differences.

For example, returning to FIG. 4, the measurement can be calibrated using conventional acoustic ranging techniques, including both pulse and spread spectrum. Each of the IPDs 130 may be co-located with an acoustic node, either source or reciever (not shown). The acoustic source or receiver may be a node from either, for instance, an ultra short baseline (“USBL”) acoustic system, a short baseline (“SBL”) acoustic system, or a distance measuring acoustic network. Note that SBL sources and receivers or distance measuring acoustic sources may be preferred in some embodiments because they can be co-located with the IMU. Furthermore, pressure sensors in the IPDs 130 may contribute orientation information.

In the embodiment of FIG. 4, a plurality of acoustic sources 406 (only one indicated) are mounted on poles 409 (only one indicated) around the hull 412 of the deployment vessel 103 in conventional fashion. The acoustic sources 406 therefore have fixed, short baselines between the sources. These known fixed separations between the sources are the “short baselines.” (Ultra-short baselines, are on the order of centimeters and there are many more acoustic sources 406 than in the SBL implementation of FIG. 4.) These acoustic sources 406 are fixed to a single surface or face with a diameter of around a meter. The performance of the systems are a function of the distance of the baseline, (the longer the better), the number of acoustic sources 406, (the shorter baselines in USBL are compensated for by many more acoustic sources 406), and the wavelength of the ranging signals 403 (longer in the sbl case and thus less precise, very short in the usbl case to again compensate for the much shorter baselines).

The acoustic sources 406 generate acoustic ranging signals 403 (only three indicated) that are received by the acoustic receivers of the sensor modules 227. The acoustic receivers receive the acoustic ranging signals 403 and transmit them to the data collection system aboard the survey vessel 103, which then applies them to the inertial measurements to calibrate the measured position of the IPDs 130. FIG. 7 illustrates the application of this acoustic ranging calibration to the seismic survey 200 of FIG. 2. Additional corrections for sensor temperature drift, cross-axis symmetry, and non-linearities can be made through processing on, for example, the computing apparatus 500 in FIG. 5, using known techniques to still further improve accuracy.

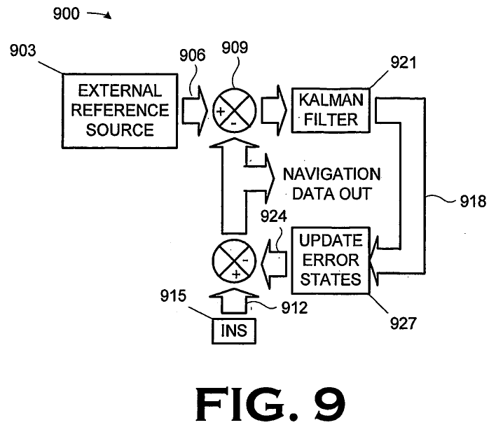

Calibration of the inertial unit can be accomplished by a variety of methods and is analogous to calibration of a strapdown IMU in an Inertial Navigation System. Kalman filter INS calibration is a well known method of estimating INS errors. One common Kalman filter often used is an open-loop system 900, illustrated in FIG. 9. In the system 900, the INS system errors are estimated from an external reference source 903, a history of coordinate estimates resulting from acoustic network measurements in this case. A minimum INS error state estimate normally contains (at 906) position, velocity and attitude errors. Residuals are formed (at 909) between the external reference source estimates (at 906) of these quantities and those estimated by the INS 915. In the open loop system 900, these error estimates are applied to the uncorrected output (at 912) of the INS 915. Updates (at 918) are calculated by the Kalman filter 921 and the error states estimates (at 924) are updated (at 927) at each measurement cycle. The measurement cycle is the solving frequency of the acoustic network. Additional external source measurements can be obtained from pressure sensors built into the INS unit to give attitude change along the three axes. Further acoustic nodes recording acoustic signals aligned with the system axes can also give attitude information.

Note that the spatial resolution of the positioning information obtained by application of the present invention will be largely determined by the number of IPDs 130, 230 that are employed. In theory, any number of IPDs 130, 230 may be employed. As a practical matter, the lower bound for any given implementation will be governed by some desired, minimal level of resolution. The upper bound will be determined by practical considerations such as weight, power consumption, bandwidth consumption, and cost. However, the number of IPDs in any given embodiment is not material to the practice of the invention. Note also that the invention is not limited to the positioning of seismic cables. The present invention may be applied to determine the position of any seismic survey object. A seismic survey object can be any object that may be employed in the conduct of a seismic survey, excluding vehicles. Thus, survey vessels, autonomous unmanned vehicles, (“UAVs”), remotely operated vehicles (“ROVs”), and the like are excluded while other pieces such as seismic cables, and acoustic sources (e.g., the acoustic sources 124 in FIG. 1, FIG. 2) are included.

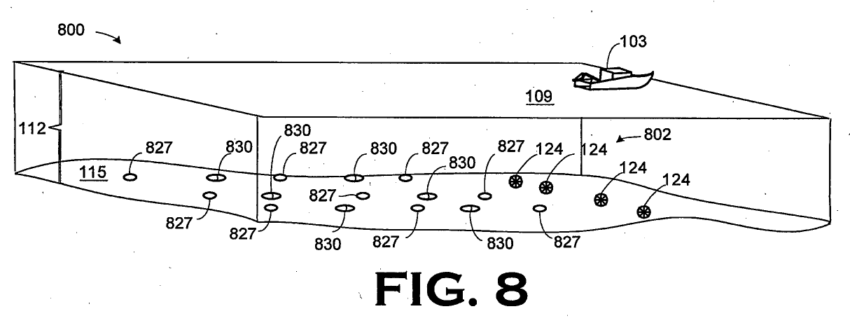

The definition seismic survey object also includes autonomous objects that are not vehicles. For instance, some embodiment may employ acoustic sources or sensor modules that are “autonomous” in the sense that they are not linked by seismic cables. Such a survey 800 is shown in FIG. 8, in which a spread 802 comprised of multiple sources 124, IPDs 830, and sensor modules 827 has been deployed to the floor 115. Each seismic survey object, i.e., source 124, IPD 830, and sensor module 827, is self-contained and carries its own power. Seismic survey objects such as the IPDs 830 and the sensor modules 827 also carry recorders that record the data they collect since there is no cable for transmission back to the survey vessel 103. After a predetermined time, the seismic survey objects can be retrieved by, for example, activating a buoyancy mechanism or retrieval with an ROV.

The present invention therefore comprises an apparatus and a method of its use in a marine seismic survey. The apparatus comprises a seismic survey object and an inertial measurement device coupled to the seismic survey object. The seismic survey object may be, for instance, a seismic cable (e.g., the OBC 106 or streamer 206 in FIG. 1, FIG. 2), a seismic receiver (e.g. as in the sensor modules 127, 227 in FIG. 1, FIG. 2), a steering device (e.g., the Q-fin, or bird, 230 in FIG. 2), a seismic source (e.g. the seismic sources 124 in FIG. 1, FIG. 2), or an acoustic source (a SBL (or USBL) source 406, shown in FIG. 4). The inertial measurement device will typically comprise, as shown in FIG. 3, an inertial measurement unit (e.g., the IMU 300), a power system for the inertial measurement unit, a communication interface, and a battery powering the power system and the communication interface (e.g., collectively, the bird components 305).

The method comprises taking inertial measurements of the movement of selected points (i.e., locations of the RMs 300) within a seismic spread relative to at least one known point (e.g., the point of deployment 400), and applying the inertial measurements to the known point to determine the positions of the selected points. The inertial measurements can be taken either during deployment, as shown in FIG. 4, or during the conduct of the survey itself, as shown in FIG. 6. The inertial measurements can be supplemented, for example, by the optional acoustic ranging technique shown in FIG. 4 and FIG. 7. Furthermore, the invention can be employed in saltwater, fresh water, or brackish water.

Thus, in its various aspects and embodiments, the present invention may provide, relative to the state of the art, one or more advantages including:
an additional observation type to calibrate non inertial observations that can increase reliability in the overall system;
continuity of positioning during periods of lost or distorted complimentary measures, such as acoustic distances or GPS control; and
depending on inertial sensor drift rates, a reduction in the frequency and number of acoustic measurements used to recalibrate the inertial system (i.e., with no drift rate, or an insignificant drift rate over the course of a deployment, and a high enough spatial frequency of inertial units, positioning could be determined without acoustics).
   Additional advantages and benefits may become apparent to those skilled in the art having the benefit of this disclosure.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed:

1. An apparatus for use in a marine seismic survey, comprising:
a seismic survey object; and
an inertial measurement unit coupled to the seismic survey object.

2. The apparatus of claim 1, wherein the seismic survey object comprises one of a seismic cable, a seismic receiver, a steering device, and a seismic source.

3. The apparatus of claim 2, wherein the seismic cable comprises one of a streamer and an ocean bottom cable.

4. The apparatus of claim 2, wherein the seismic cable includes one of a sensor module, a steering device, and an inertial positioning device in which the inertial measurement unit is housed.

5. The apparatus of claim 2, wherein the seismic cable includes a plurality of acoustic receivers.

6. The apparatus of claim 2, wherein the steering device comprises one of a Q-fin and a bird.

7. The apparatus of claim 2, wherein the seismic source comprises at least one of an air gun and a vibrator.

8. The apparatus of claim 1, further comprising an inertial positioning device in which the inertial measurement unit is housed.

9. The apparatus of claim 1, wherein the inertial positioning device further comprises:
a power system for the inertial measurement unit;
a communication interface; and
a battery powering the power system and the communication interface.

10. The apparatus of claim 1, wherein the inertial measurement unit comprises a plurality of accelerometers and gyroscopes.

11. The apparatus of claim 1, wherein the inertial measurement unit comprises a micro-electromechanical inertial measurement unit.

12. The apparatus of claim 8, wherein the inertial positioning device further comprises an acoustic node determined by either an acoustic source or receiver.

13. The apparatus of claim 12, wherein the acoustically determined point comprises one of an ultra-short baseline acoustic system, a short baseline acoustic system, or a distance measurement acoustic system.

14. A marine seismic spread, comprising:
a plurality of seismic survey objects, including a plurality of acoustic receivers and at least one acoustic source, distributed over a survey area from at least one known point; and
a plurality of inertial positioning devices coupled to the seismic survey objects and capable of taking inertial measurements of the movement of the seismic survey objects relative to the known point.

15. The marine seismic spread of claim 14, wherein the plurality of seismic survey objects include a plurality of seismic cables comprised of the acoustic sources and the inertial positioning devices.

16. The marine seismic spread of claim 15, wherein the seismic cables comprise one of a plurality of streamers and a plurality of ocean bottom cables.

17. The marine seismic spread of claim 14, wherein the seismic survey objects include a one of a plurality of a plurality of inertial positioning devices and a plurality of steering devices in which the inertial positioning devices are housed.

18. The marine seismic spread of claim 14, wherein the plurality of acoustic receivers comprise a plurality of hydrophones or geophones.

19. The marine seismic spread of claim 14, wherein the inertial measurement unit is housed in an inertial positioning device.

20. The marine seismic spread of claim 18, in which the inertial positioning device further comprises:
a power system for the inertial measurement units;
a communication interface; and
a battery powering the power system and the communication interface.

21. The marine seismic spread of claim 14, wherein at least one of the inertial measurement units comprises a plurality of accelerometers and gyroscopes.

22. The marine seismic spread of claim 14, wherein at least one of the inertial measurement units comprises a micro-electromechanical inertial measurement unit.

23. The marine seismic spread of claim 19, wherein the inertial positioning device further comprises an acoustic node determined by either an acoustic source or receiver.

24. The marine seismic spread of claim 23, wherein the acoustic source comprises one of an ultra-short baseline acoustic system, a short baseline acoustic system, or a distance measurement acoustic system.

25. An apparatus for use in a marine seismic survey, comprising:
a seismic cable; and
an inertial measurement unit coupled to the seismic cable.

26. The apparatus of claim 25, wherein the seismic cable comprises one of a streamer and an ocean bottom cable.

27. The apparatus of claim 25, wherein the seismic cable includes one of a sensor module, a steering device, and an inertial positioning device in which the inertial measurement unit is housed.

28. The apparatus of claim 25, wherein the seismic cable includes a plurality of acoustic receivers.

29. The apparatus of claim 28, wherein the plurality of acoustic receivers comprise a plurality of hydrophones or a plurality of geophones.

30. The apparatus of claim 25, wherein the inertial measurement unit is housed within an inertial positioning device.

31. The apparatus of claim 30, wherein the inertial positioning device further comprises:
a power system for the inertial measurement units;
a communication interface; and
a battery powering the power system and the communication interface.

32. The apparatus of claim 25, wherein at least one of the inertial measurement units comprises a plurality of accelerometers and gyroscopes.

33. The apparatus of claim 25, wherein at least one of the inertial measurement units comprises a micro-electromechanical inertial measurement unit.

34. The apparatus of claim 30, wherein the inertial positioning device further comprises an acoustic node determined by either an acoustic source or receiver.

35. The apparatus of claim 34, wherein the acoustic source comprises one of an ultra-short baseline acoustic system, a short baseline acoustic system, or a distance measurement acoustic system.

36. A method for use in a marine seismic survey, comprising:
taking inertial measurements of movement of selected points on a seismic spread relative to at least one known point; and
applying the inertial measurements to the known point to determine the positions of the selected points.

37. The method of claim 36, wherein taking the inertial measurements includes taking the inertial measurements during at least one of deploying the spread, retrieving the spread and conducting a survey.

38. The method of claim 36, further comprising supplementing the inertial measurements.

39. The method of claim 38, wherein supplementing the inertial measurements comprises at least one of calibrating the positions using a coordinate history determined from acoustic ranging signals and integrating one dimensional measures such as acoustic ranges, range differences and pressure differences.

40. The method of claim 36, further comprising deploying the seismic spread at the known point.

41. The method of claim 40, wherein deploying the seismic spread at the known point includes one of deploying the seismic spread to the bottom of a body of water and deploying the seismic spread near to the surface of the body of water.

42. The method of claim 40, wherein deploying the seismic spread at the known point includes deploying the seismic spread in one of saltwater, fresh water, and brackish water.

43. The method of claim 36, further comprising housing an inertial measurement unit in a seismic survey object.

44. The method of claim 43, wherein housing the inertial measurement unit in a seismic survey object includes housing the inertial measurement unit in one of a seismic cable, a seismic receiver, a steering device, and a seismic source.

45. The method of claim 36, wherein taking inertial measurements of the movement of selected points on the seismic spread includes taking inertial measurements of the movement of selected seismic survey objects.

46. The method of claim 45, wherein taking inertial measurements of the movement of selected seismic survey objects includes taking inertial measurements of the movement of at least one of a seismic cable, a seismic receiver, a steering device, and a seismic source.

47. The method of claim 36, wherein the seismic cable includes seismic survey objects having known relative orientations with respect to the selected points on the seismic cable, and the method further comprises determining positions of the selected seismic survey objects based on the determined positions of the selected points and the known relative orientations.

48. A method for use in a marine seismic survey, comprising:
deploying a seismic cable at a known point;
taking inertial measurements of movement of selected points on the seismic cable relative to the known point during the deployment; and
applying the inertial measurements to the known point to determine the positions of the selected points.

49. The method of claim 48, wherein the seismic cable includes seismic survey objects having known relative orientations with respect to the selected points on the seismic cable, and the method further comprises determining positions of the selected seismic survey objects based on the determined positions of the selected points and the known relative orientations.

50. The method of claim 48, wherein deploying the seismic cable comprises one of deploying the seismic cable to the bottom of the water and deploying the seismic cable near to the surface of the water.

51. The method of claim 48, further comprising supplementing the inertial measurements.

52. The method of claim 51, wherein supplementing the inertial measurements comprises at least one of calibrating the positions using a coordinate history determined from acoustic ranging signals and integrating one dimensional measures such as acoustic ranges, range differences and pressure differences.

53. The method of claim 51, wherein deploying the seismic cable at the known point includes one of deploying the seismic cable to the bottom of a body of water and deploying the seismic cable near to the surface of the body of water.

54. The method of claim 51, wherein deploying the seismic cable at the known point includes deploying the seismic cable in one of saltwater, fresh water, and brackish water.

55. The method of claim 48, further comprising housing an inertial measurement unit in a seismic survey object comprising a portion of the seismic cable.

56. The method of claim 55, wherein housing the inertial measurement unit in a seismic survey object includes housing the inertial measurement unit in one of a seismic receiver, a steering device, and a seismic source.

57. The method of claim 48, wherein taking inertial measurements of the movement of selected points on the seismic cable includes taking inertial measurements of the movement of selected seismic survey objects comprising a portion of the seismic cable.

58. The method of claim 57, wherein taking inertial measurements of the movement of selected seismic survey objects includes taking inertial measurements of the movement of at least one of a seismic receiver, a steering device, and a seismic source.

59. A method for use in a marine seismic survey, comprising:
conducting a survey with a seismic spread deployed from at least one known point;
taking inertial measurements of movement of selected points on the seismic spread relative to the known point during the conduct of the seismic survey; and
applying the inertial measurements to the known point to determine the positions of the selected points.

60. The method of claim 59, further comprising supplementing the inertial measurements.

61. The method of claim 60, wherein supplementing the inertial measurements comprises at least one of calibrating the positions using a coordinate history determined from acoustic ranging signals and integrating one dimensional measures such as acoustic ranges, range differences and pressure differences.

62. The method of claim 59, further comprising deploying the seismic spread at the known point.

63. The method of claim 62, wherein deploying the seismic spread at the known point includes one of deploying the seismic spread to the bottom of a body of water and deploying the seismic spread to the surface of the body of water.

64. The method of claim 62, wherein deploying the seismic spread at the know point includes deploying the seismic spread in one of saltwater, fresh water, and brackish water.

65. The method of claim 59, further comprising housing an inertial measurement unit in a seismic survey object.

66. The method of claim 65, wherein housing the inertial measurement unit in a seismic survey object includes housing the inertial measurement unit in one of a seismic cable, a seismic receiver, a steering device, and a seismic source.

67. The method of claim 59, wherein taking inertial measurements of the movement of selected points on the seismic spread includes taking inertial measurements of the movement of selected seismic survey objects.

68. The method of claim 67, wherein taking inertial measurements of the movement of selected seismic survey objects includes taking inertial measurements of the movement of at least one of a seismic cable, a seismic receiver, a steering device, and a seismic source.

69. The method of claim 59, wherein the seismic cable includes seismic survey objects having known relative orientations with respect to the selected points on the seismic cable, and the method further comprises determining positions of the selected seismic survey objects based on the determined positions of the selected points and the known relative orientations.
